(19) United States
(12) Patent Application Publication
(10) Pub. No.: US 2026/0239178 A1
(43) Pub. Date: Aug. 13, 2026

(54) USER EQUIPMENT COOPERATION FOR ASSISTED SYSTEM INFORMATION ACQUISITION

(71) Applicant: QUALCOMM Incorporated, San Diego, CA (US)

(72) Inventors: Tommy AZZINO, Jersey City, NJ (US); Navid ABEDINI, Basking Ridge, NJ (US); Diana MAAMARI, San Diego, CA (US)

(21) Appl. No.: 19/050,404

(22) Filed: Feb. 11, 2025

(51) Int. Cl. H04W 48/14

(52) U.S. Cl. CPC H04W 48/14

(57) ABSTRACT

Methods, systems, and devices for wireless communication are described. For example, the method may include establishing a relationship between the first UE and a second UE, where the relationship includes assistance, by the first UE, in acquisition of on-demand system information by the second UE, acquiring first information associated with acquisition, on behalf of the second UE, of on-demand system information, and transmitting, based on the first information, one or more on-demand system information requests. The first information may include, for example, a maximum allowable quantity of retransmissions of the one or more on-demand system information requests or an assistance request limit applicable to the second UE. The first UE may provide, to the second UE, an indication of a result of transmission of the one or more on-demand system information requests.

### FIELD OF TECHNOLOGY

The following relates to wireless communication, including user equipment cooperation for assisted system information acquisition.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first user equipment (UE) is described. The method may include establishing a relationship between the first UE and a second UE, where the relationship includes assistance, by the first UE, in acquisition of on-demand system information by the second UE, acquiring first information associated with acquisition, on behalf of the second UE, of on-demand system information, and transmitting, based on the first information, one or more on-demand system information requests.

A first UE for wireless communications is described. The first UE may include one or more memories storing processor executable code, and one or more processors coupled with the one or more memories. The one or more processors may individually or collectively be operable to execute the code to cause the first UE to establish a relationship between the first UE and a second UE, where the relationship includes assistance, by the first UE, in acquisition of on-demand system information by the second UE, acquire first information associated with acquisition, on behalf of the second UE, of on-demand system information, and transmit, based on the first information, one or more on-demand system information requests.

Another first UE for wireless communications is described. The first UE may include means for establishing a relationship between the first UE and a second UE, where the relationship includes assistance, by the first UE, in acquisition of on-demand system information by the second UE, means for acquiring first information associated with acquisition, on behalf of the second UE, of on-demand system information, and means for transmitting, based on the first information, one or more on-demand system information requests.

A non-transitory computer-readable medium storing code for wireless communications is described. The code may include instructions executable by one or more processors to establish a relationship between the first UE and a second UE, where the relationship includes assistance, by the first UE, in acquisition of on-demand system information by the second UE, acquire first information associated with acquisition, on behalf of the second UE, of on-demand system information, and transmit, based on the first information, one or more on-demand system information requests.

In some examples of the method, first UEs, and non-transitory computer-readable medium described herein, acquiring the first information may include operations, features, means, or instructions for acquiring an indication of a maximum allowable quantity of retransmissions of the one or more on-demand system information requests.

In some examples of the method, first UEs, and non-transitory computer-readable medium described herein, the maximum allowable quantity of retransmissions may be based on a maximum quantity of system information requests defined in a target cell.

In some examples of the method, first UEs, and non-transitory computer-readable medium described herein, acquiring the indication of the maximum allowable quantity of retransmissions may include operations, features, means, or instructions for receiving the indication from the second UE.

In some examples of the method, first UEs, and non-transitory computer-readable medium described herein, establishing the relationship may include operations, features, means, or instructions for transmitting, to the second UE, an indication of a first maximum allowable quantity of retransmissions of the one or more on-demand system information requests.

Some examples of the method, first UEs, and non-transitory computer-readable medium described herein may further include operations, features, means, or instructions for selecting the first maximum allowable quantity of retransmissions of the one or more on-demand system information requests based on an estimated link budget of a link between the first UE and a target cell associated with the on-demand system information.

In some examples of the method, first UEs, and non-transitory computer-readable medium described herein, the first maximum allowable quantity of retransmissions of the one or more on-demand system information requests pertains to acquisition of the on-demand system information from a first target cell and the method, apparatuses, and non-transitory computer-readable medium may include further operations, features, means, or instructions for transmitting a second indication of a second maximum quantity of retransmissions of the one or more on-demand system information requests pertaining to acquisition of second on-demand system information from a second target cell.

In some examples of the method, first UEs, and non-transitory computer-readable medium described herein, establishing the relationship may include operations, features, means, or instructions for receiving, from the second UE and based on an assistance request limit associated with assistance in acquisition of on demand system information, one or more requests for the assistance in acquisition of on-demand system information, where the one or more on-demand system information requests may be transmitted based on the received one or more requests.

In some examples of the method, first UEs, and non-transitory computer-readable medium described herein, acquiring the first information may include operations, features, means, or instructions for acquiring an indication of the assistance request limit that may be associated with a time duration during which the assistance request limit may be applicable.

In some examples of the method, first UEs, and non-transitory computer-readable medium described herein, establishing the relationship may include operations, features, means, or instructions for transmitting, to the second UE, an indication of the assistance request limit that may be associated with a time duration during which the assistance request limit may be applicable.

In some examples of the method, first UEs, and non-transitory computer-readable medium described herein, transmitting the one or more on-demand system information requests may include operations, features, means, or instructions for transmitting respective one or more on-demand system information requests for each received request for the assistance.

Some examples of the method, first UEs, and non-transitory computer-readable medium described herein may further include operations, features, means, or instructions for monitoring for receipt of the on-demand system information or feedback in response to transmitting the one or more on-demand system information requests and transmitting, to the second UE, second information indicative of a result of monitoring for the on-demand system information or the feedback.

In some examples of the method, first UEs, and non-transitory computer-readable medium described herein, transmitting the second information may include operations, features, means, or instructions for transmitting an indication of the result that indicates that the first UE failed to acquire the on-demand system information in response to the one or more on-demand system information requests or failed to receive feedback associated with the one or more on-demand system information requests.

In some examples of the method, first UEs, and non-transitory computer-readable medium described herein, transmitting the second information may include operations, features, means, or instructions for transmitting, based on the result being that the first UE failed to receive the feedback, a request for third information indicative of whether the second UE received the feedback.

Some examples of the method, first UEs, and non-transitory computer-readable medium described herein may further include operations, features, means, or instructions for transmitting, based on the second information, one or more additional on-demand system information requests.

In some examples of the method, first UEs, and non-transitory computer-readable medium described herein, transmitting the second information may include operations, features, means, or instructions for transmitting, based on the result being that the first UE received the feedback, an indication that the first UE received the feedback.

In some examples of the method, first UEs, and non-transitory computer-readable medium described herein, the second information further includes an indication of a resource via which the second UE may be to monitor for the on-demand system information.

In some examples of the method, first UEs, and non-transitory computer-readable medium described herein, establishing the relationship may include operations, features, means, or instructions for transmitting an indication of an uplink resource via which the first UE and the second UE may be to transmit respective one or more on-demand system information requests, where the one or more on-demand system information requests may be transmitted via the uplink resource.

Some examples of the method, first UEs, and non-transitory computer-readable medium described herein may further include operations, features, means, or instructions for transmitting, to the second UE, a third UE, or both, second information indicative of a quantity of transmissions of the one or more on-demand system information requests.

In some examples of the method, first UEs, and non-transitory computer-readable medium described herein, establishing the relationship may include operations, features, means, or instructions for transmitting cell information indicative of a public land mobile network identifier, a tracking area code, a radio access network area code, unified access control information, or a combination thereof.

In some examples of the method, first UEs, and non-transitory computer-readable medium described herein, establishing the relationship may include operations, features, means, or instructions for transmitting cell information indicative of a configuration of system information transmissions by a target cell, where the configuration indicates that the target cell transmits periodic system information of a first type, the on-demand system information of the first type, no system information of the first type, on-demand system information of a second type, or a combination thereof.

In some examples of the method, first UEs, and non-transitory computer-readable medium described herein, establishing the relationship may include operations, features, means, or instructions for transmitting an indication of a configuration associated with transmission of an uplink wake-up signal.

In some examples of the method, first UEs, and non-transitory computer-readable medium described herein, acquiring the first information may include operations, features, means, or instructions for receiving, from a network entity, the first information indicative of a maximum quantity of retransmissions of an on-demand system information request, a time duration during which the maximum quantity of retransmissions may be applicable, a power ramping configuration associated with the assistance in acquisition of the on-demand system information, or a combination thereof.

In some examples of the method, first UEs, and non-transitory computer-readable medium described herein, establishing the relationship may include operations, features, means, or instructions for transmitting, to the second UE, value tag information associated with one or more elements of system information acquired by the first UE.

In some examples of the method, first UEs, and non-transitory computer-readable medium described herein, acquiring the first information may include operations, features, means, or instructions for receiving, from the second UE, value tag information associated with one or more elements of system information acquired by the second UE.

A method for wireless communications by a first UE is described. The method may include establishing a relationship between the first UE and a second UE, where the relationship includes assistance, by the second UE, in acquisition of on-demand system information by the first UE, acquiring, from the second UE, first information associated with acquisition, by the second UE on behalf of the first UE, of the on-demand system information, and monitoring, based on the first information, for receipt of the on-demand system information.

A first UE for wireless communications is described. The first UE may include one or more memories storing processor executable code, and one or more processors coupled with the one or more memories. The one or more processors may individually or collectively be operable to execute the code to cause the first UE to establish a relationship between the first UE and a second UE, where the relationship includes assistance, by the second UE, in acquisition of on-demand system information by the first UE, acquire, from the second UE, first information associated with acquisition, by the second UE on behalf of the first UE, of the on-demand system information, and monitor, based on the first information, for receipt of the on-demand system information.

Another first UE for wireless communications is described. The first UE may include means for establishing a relationship between the first UE and a second UE, where the relationship includes assistance, by the second UE, in acquisition of on-demand system information by the first UE, means for acquiring, from the second UE, first information associated with acquisition, by the second UE on behalf of the first UE, of the on-demand system information, and means for monitoring, based on the first information, for receipt of the on-demand system information.

A non-transitory computer-readable medium storing code for wireless communications is described. The code may include instructions executable by one or more processors to establish a relationship between the first UE and a second UE, where the relationship includes assistance, by the second UE, in acquisition of on-demand system information by the first UE, acquire, from the second UE, first information associated with acquisition, by the second UE on behalf of the first UE, of the on-demand system information, and monitor, based on the first information, for receipt of the on-demand system information.

In some examples of the method, first UEs, and non-transitory computer-readable medium described herein, acquiring the first information may include operations, features, means, or instructions for acquiring an indication of a maximum allowable quantity of retransmissions, by the second UE, of one or more on-demand system information requests.

In some examples of the method, first UEs, and non-transitory computer-readable medium described herein, establishing the relationship may include operations, features, means, or instructions for transmitting, to the second UE, one or more requests for a quantity of retransmissions, by the second UE, of an on-demand system information request.

Some examples of the method, first UEs, and non-transitory computer-readable medium described herein may further include operations, features, means, or instructions for receiving, from the second UE, an indication of rejection of a first request of the one or more requests.

In some examples of the method, first UEs, and non-transitory computer-readable medium described herein, establishing the relationship may include operations, features, means, or instructions for transmitting, to the second UE, a request for a quantity of retransmissions, by the second UE, of an on-demand system information request.

In some examples of the method, first UEs, and non-transitory computer-readable medium described herein, establishing the relationship may include operations, features, means, or instructions for transmitting, to the second UE and based on an assistance request limit associated with assistance in acquisition of on demand system information, one or more requests for the assistance in acquisition of on-demand system information.

In some examples of the method, first UEs, and non-transitory computer-readable medium described herein, acquiring the first information may include operations, features, means, or instructions for receiving, from the second UE, an indication of the assistance request limit that may be associated with a time duration during which the assistance request limit may be applicable.

Some examples of the method, first UEs, and non-transitory computer-readable medium described herein may further include operations, features, means, or instructions for receiving, from the second UE, second information that indicates that the second UE failed to acquire the on-demand system information in response transmission, by the second UE, of one or more first on-demand system information requests or failed to receive feedback associated with transmission of the one or more first on-demand system information requests.

Some examples of the method, first UEs, and non-transitory computer-readable medium described herein may further include operations, features, means, or instructions for transmitting, based on the second information, one or more second on-demand system information requests.

In some examples of the method, first UEs, and non-transitory computer-readable medium described herein, transmitting the one or more second on-demand system information requests may include operations, features, means, or instructions for transmitting a second on-demand system information requests using a transmit power that may be irrespective of a quantity the one or more first on-demand system information requests.

In some examples of the method, first UEs, and non-transitory computer-readable medium described herein, transmitting the one or more second on-demand system information requests may include operations, features, means, or instructions for transmitting a second on-demand system information requests using a transmit power that may be based on a quantity the one or more first on-demand system information requests.

In some examples of the method, first UEs, and non-transitory computer-readable medium described herein, transmitting the one or more second on-demand system information requests may include operations, features, means, or instructions for transmitting, using respective transmission powers that increase with each successive transmission, the one or more second on-demand system information requests until satisfaction of a maximum quantity of on-demand system information requests.

Some examples of the method, first UEs, and non-transitory computer-readable medium described herein may further include operations, features, means, or instructions for receiving, from the second UE, an indication of an uplink resource via which the first UE and the second UE may be to transmit respective one or more on-demand system information requests and transmitting, based on the indication and via the uplink resource, one or more on-demand system information requests.

Some examples of the method, first UEs, and non-transitory computer-readable medium described herein may further include operations, features, means, or instructions for receiving, from the second UE, a request for second information that indicates whether the first UE received the on-demand system information in response transmission, by the second UE, of one or more on-demand system information requests, by the second UE, or whether the first UE received feedback associated with the one or more on-demand system information requests.

Some examples of the method, first UEs, and non-transitory computer-readable medium described herein may further include operations, features, means, or instructions for transmitting, to the second UE, one or more third UEs, or both, second information that indicates that the first UE received feedback associated with transmission, by the second UE, of one or more on-demand system information requests.

In some examples of the method, first UEs, and non-transitory computer-readable medium described herein, monitoring for the on-demand system information may include operations, features, means, or instructions for monitoring, during a time duration, for receipt of the on-demand system information from the second UE, a network entity, or both and monitoring, during the time duration, for receipt of feedback associated with transmission, by the second UE, of one or more on-demand system information requests.

Some examples of the method, first UEs, and non-transitory computer-readable medium described herein may further include operations, features, means, or instructions for transmitting, to a third UE after expiration of a time duration during which the first UE monitors for the on-demand system information, a request for assistance, by the third UE, in acquisition of the on-demand system information by the first UE.

Some examples of the method, first UEs, and non-transitory computer-readable medium described herein may further include operations, features, means, or instructions for transmitting, to a third UE after receiving information indicative of failure, by the second UE, to receive the on-demand system information or feedback associated with transmission, by the second UE, of one or more on-demand system information requests.

Some examples of the method, first UEs, and non-transitory computer-readable medium described herein may further include operations, features, means, or instructions for receiving, from the second UE, second information that includes an indication that the second UE received feedback associated with transmission, by the second UE, of one or more on-demand system information requests.

In some examples of the method, first UEs, and non-transitory computer-readable medium described herein, the second information further includes an indication of a resource via which the second UE may be to monitor for the on-demand system information.

In some examples of the method, first UEs, and non-transitory computer-readable medium described herein, acquiring the first information may include operations, features, means, or instructions for receiving, from the second UE, cell information indicative of a public land mobile network identifier, a tracking area code, a radio access network area code, unified access control information, or a combination thereof.

In some examples of the method, first UEs, and non-transitory computer-readable medium described herein, acquiring the first information may include operations, features, means, or instructions for receiving, from the second UE, cell information indicative of a configuration of system information transmissions by a target cell, where the configuration indicates that the target cell transmits periodic system information of a first type, the on-demand system information of the first type, no system information of the first type, on-demand system information of a second type, or a combination thereof.

In some examples of the method, first UEs, and non-transitory computer-readable medium described herein, acquiring the first information may include operations, features, means, or instructions for receiving, from the second UE, an indication of a configuration associated with transmission of an uplink wake-up signal.

In some examples of the method, first UEs, and non-transitory computer-readable medium described herein, acquiring the first information may include operations, features, means, or instructions for receiving, from the second UE, value tag information associated with one or more elements of system information acquired by the second UE.

In some examples of the method, first UEs, and non-transitory computer-readable medium described herein, acquiring the first information may include operations, features, means, or instructions for transmitting, to the second UE, first tag information associated with one or more elements of system information acquired by first UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports user equipment cooperation for assisted system information acquisition in accordance with one or more aspects of the present disclosure.

FIG. 2 shows an example of a wireless communications system that supports user equipment cooperation for assisted system information acquisition in accordance with one or more aspects of the present disclosure.

FIG. 3 shows an example of a process flow that supports user equipment cooperation for assisted system information acquisition in accordance with one or more aspects of the present disclosure.

FIGS. 4 and 5 show block diagrams of devices that support user equipment cooperation for assisted system information acquisition in accordance with one or more aspects of the present disclosure.

FIG. 6 shows a block diagram of a communications manager that supports user equipment cooperation for assisted system information acquisition in accordance with one or more aspects of the present disclosure.

FIG. 7 shows a diagram of a system including a device that supports user equipment cooperation for assisted system information acquisition in accordance with one or more aspects of the present disclosure.

FIGS. 8 and 9 show flowcharts illustrating methods that support user equipment cooperation for assisted system information acquisition in accordance with one or more aspects of the present disclosure.

### DETAILED DESCRIPTION

In some wireless communication systems, a user equipment (UE) may perform various operations to establish a connection with (e.g., access) a cell of a network entity. For instance, a UE may perform one or more operations such as cell search operations (e.g., blind searching across various parameters including time resources, frequency resources, spatial resources, cell identifiers), cell selection operations, cell reselection operations, system information acquisition, or other operations to obtain (e.g., receive, acquire, detect) information that facilitates connection with the cell. In some cases, each UE that connects to the cell may perform a same set of operations to establish their respective connections, and at least some UEs may be located relatively close together (e.g., within a threshold distance of each other).

Each of the UEs (e.g., closely-located UEs) may obtain the same (or substantially similar) results after performing such cell selection operations (e.g., based on being associated with a same geographic area and/or with similar network conditions). For instance, nearby UEs may obtain a same set of measurement results (e.g., synchronization signal block (SSB) search results, SSB measurement results) for connecting with the cell and/or a same set of system information (e.g., may decode one or more same system information blocks (SIBs)). Thus, performance of the cell searching operations (e.g., or other related operations) by each of the UEs may be relatively redundant and result in excessive resource consumption, increased signaling overhead, and other inefficiencies in a wireless communications system.

Various aspects relate generally to wireless communications and more particularly to signaling to support acquisition of on-demand system information and of the on-demand system information to one or more other UEs. Some aspects more specifically related to, an assisting UE (e.g., the UE that is helping other UEs acquire system information) and an assisted UE (e.g., the UE that is using the assisting UE to acquire system information) transmitting such signaling to configure various parameters for acquisition of the system information. Such signaling may be used to communicate information such as a quantity of on-demand system information requests to be transmitted by the assisting UE, a quantity of requests for system information allowed to be transmitted to the assisting UE by the assisted UE, and cell-related information. The signaling may also support UE behavior when the assisting or the assisted UE fails to acquire on-demand system information or feedback for on-demand system information requests. The signaling may also support power ramping behavior by the assisting UE, the assisted UE, or another assisting UE. In some examples, the network may configure various aspects at the assisting UE(s) or the assisted UEs.

Particular aspects of the subject matter described in this disclosure may be implemented to realize one or more of the following potential advantages. In some examples, by using signaling to coordinate acquisition of system information, the described techniques may be used to support reduced signaling between UEs and network entities, which may support reduced power consumption, reduced signaling overhead, and improved response times, among other benefits. These and other techniques are described in further detail with respect to the figures.

Aspects of the disclosure are initially described in the context of wireless communications systems. Aspects of the disclosure are further illustrated and described with respect to a wireless communications system illustrating assisted system information acquisition and a process flow illustrating example operations for assisted system information acquisition. Aspects of the disclosure are further illustrated by and described with reference to apparatus diagrams, system diagrams, and flowcharts that relate to user equipment cooperation for assisted system information acquisition.

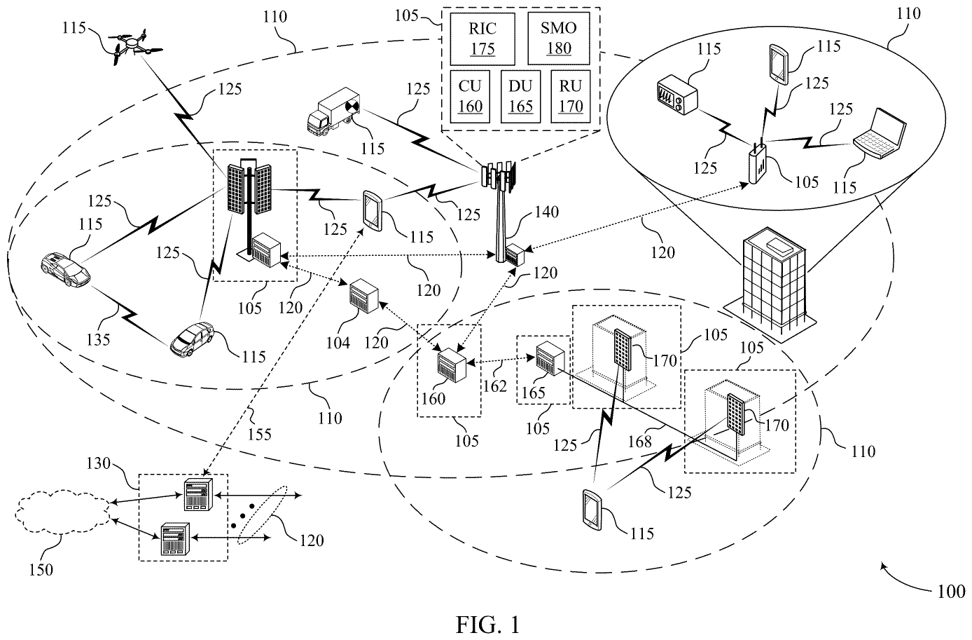

FIG. 1 shows an example of a wireless communications system 100 that supports user equipment cooperation for assisted system information acquisition in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support user equipment cooperation for assisted system information acquisition as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may be configured to transmit (e.g., share, convey, broadcast, output) cell selection information (e.g., cell measurement-related information, system information, cell reselection information) to one or more other UEs. The cell selection information may facilitate one or more cell selection (e.g., and/or cell reselection) operations by the other UEs (e.g., a simplified cell selection operation, a reduced cell selection operation). For example, a first UE 115 may perform a first search operation and may obtain some information associated with cell selection and/or cell reselection. The first UE 115 may transmit the obtained information to one or more second UEs 115.

To support transmission of such system information, in accordance with techniques described herein, the first UE 115 (e.g., the assisting UE) may establishing a relationship (e.g., a communication link) between the first UE 115 and a second UE 115 (e.g., the assisted UE). During or in response to establishing the relationship, the first UE 115 and the second UE 115 may exchange information, such as a quantity of on-demand system information requests to be transmitted by the assisting UE, a quantity of requests for system information allowed to transmitted to the assisting UE by the assisted UE, and cell-related information. The signaling between the first UE 115 and the second UE 115 may also support UE behavior when the assisting or the assisted UE fails to acquire on-demand system information, feedback for on-demand system information requests. The signaling may also support or configure power ramping behavior by the assisting UE, the assisted UE, or another assisting UE. In some examples, a network entity 105 may transmit signaling such as to configure various aspects at the assisting UE(s) or the assisted UEs. Accordingly, each of the second UEs 115 may use the shared information to simplify their own one or more cell search operations (e.g., cell selection. cell reselection, system information acquisition), thus reducing redundant resource consumption. Accordingly, by applying one or more techniques described herein, a wireless communications system 100 may support reduced power consumption, reduced signaling overhead, improved response times, and other benefits.

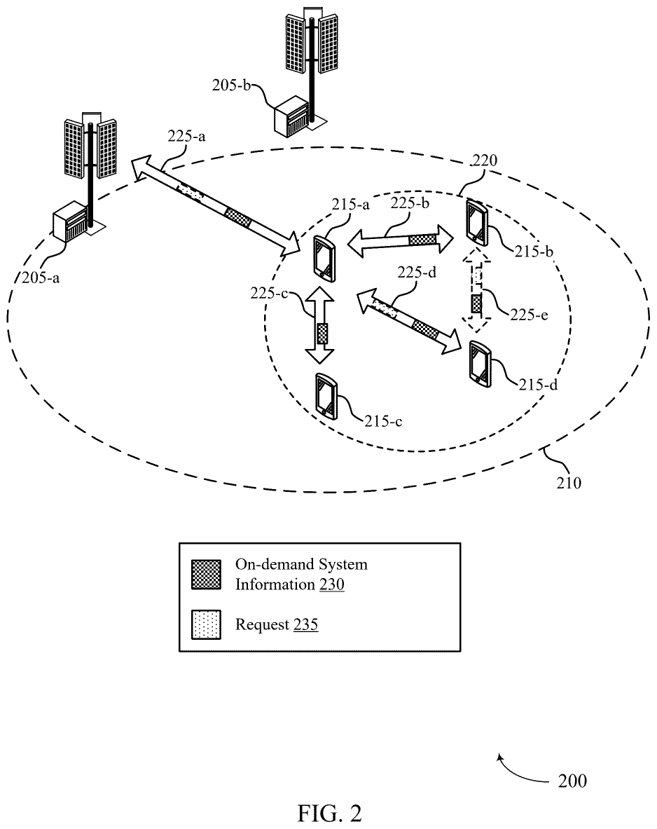

FIG. 2 shows an example of a wireless communications system 200 that supports user equipment cooperation for assisted system information acquisition in accordance with one or more aspects of the present disclosure. The wireless communications system 200 may implement or be implemented by aspects of the wireless communications system 100 as described with reference to FIG. 1. For example, the wireless communications system 200 may include a UE 215-a, a UE 215-b, a UE 215-c, a UE 215-d, a network entity 205-a, and a network entity 205-b, which may represent examples of corresponding devices described herein, including with reference to FIG. 1 (e.g., UEs 115, network entities 105).

The UEs 215 and the network entities 205 may communicate with each other via respective communication links 225 (e.g., links 125 as shown in FIG. 1, communication link 225-a, communication link 225-b, communication link 225-c, communication link 225-d, communication link 225-e) and may exchange signaling (e.g., on-demand system information 230, a request 235, or other signaling) to support the one or more techniques described herein. The network entity 205-a may be associated with a cell or a coverage area 210 (e.g., a first cell, a coverage area 110), which may be accessed (e.g., selected) by the UEs 215. The network entity 205-b may also be associated with a coverage area (not shown), which may at least partially overlap with the coverage area 210 or may not overlap with the coverage area 210. Although, the techniques herein are described with reference to network entities 205 and UEs 215, the same or similar techniques may be applied other wireless devices (e.g., including as described with reference to FIG. 1).

In some systems, a UE 215 may support one or more procedures (e.g., in a radio resource control (RRC) idle state or RRC inactive state) such as cell selection, cell reselection, system information acquisition, paging message communication, and radio access network (RAN) area registration in order to select and connect with a cell (e.g., of a network entity 205). Such procedures may be performed by each UE 215 to establish respective connections with the cell and the corresponding network entity 205. For instance, during initial cell selection (e.g., and/or cell reselection) each UE 215 may search (e.g., blindly, without any previously obtained information) across time resources (e.g., slots, symbols), frequency resources (e.g., synchronization rasters, frequency resource blocks), spatial resources (e.g., beams, transmission configuration indicator (TCI) states), cell identifiers (IDs), or other parameters, and each UE 215 may be expected to perform their own respective operations for procedures such as cell search and system information acquisition.

A system information acquisition procedure performed by a UE 215 may include a series of operations. As an illustrative example, in a first operation, the UE 215 may power on. In a second operation, the UE 215 may decode a primary synchronization signal (PSS) and a secondary synchronization signal (SSS) (e.g., UE frequency and time synchronization) and may calculate a physical cell ID (PCI). In a third operation, the UE 215 may decode a physical broadcast channel (PBCH) demodulation reference signal (DMRS). In a fourth operation, the UE 215 may further decode the PBCH to acquire a master information block (MIB) (e.g., UE reads minimum system information, which may include subcarrier spacing (SCS) for system information blocks (SIBs), physical downlink control channel (PDCCH) configuration for SIB1, indication if cell is barred). In a fifth operation, the UE 215 may determine whether the cell (e.g., the detected cell) is barred. If the cell is barred, the UE 215 may attempt to acquire another cell and return to perform the second operation. If the cell is not barred, the UE 215 may continue to a sixth operation. In the sixth operation, the UE 215 may perform PDCCH decoding (e.g., decode a location of SIB1). In a seventh operation, the UE 215 may perform PDSCH decoding for SIB1 (e.g., including decoding a location of SIB1 for public land mobile network (PLMN) ID, cell selection parameters, random access channel (RACH) parameters). In an eighth operation, the UE 215 may determine whether a PLMN matches. If the PLMN does not match, the UE 215 may attempt to acquire another cell and return to perform the second operation. If the PLMN does match, the UE 215 may proceed to a ninth operation. In the ninth operation, the UE 215 may determine whether cell selection is successful. If the cell selection is not successful, the UE 215 may attempt to acquire another cell and return to perform the second operation. If the cell selection is successful, the UE 215 may be ready for a RACH (e.g., initial access) procedure.

In some cases, the UEs 215 may also support a relay communication framework (e.g., a layer 2 (L2) U2N framework) in which a relay UE 215 may help a remote UE 215 acquire or re-acquire relevant system information when system information changes. For instance, the system information may be forwarded to a U2N remote UE in a unicast manner (e.g., one relay UE helping one remote UE). For instance, a U2N Relay UE (e.g., a UE 215-a) may assist a U2N Remote UE (e.g., a UE 215-d) by providing system information, forwarding broadcast and/or multicast messages received from the cell, and managing resources (e.g., higher-layer signaling information used for network access and connectivity). To establish this assistance, the U2N Relay UE may perform a full set of evaluation and configuration operations. Subsequently, communications may be unicast between one U2N Relay UE and one U2N Remote UE. In some cases, a U2N relay framework may assume specific L1 and L2 technology between UEs 215.

The various devices of a wireless communications system 200 may support UE-assisted access techniques to improve efficiency and reduce resource consumption (e.g., improve power savings). For example, access procedures performed by an idle UE or an inactive UEs (e.g., UE 215-b, UE 215-c, UE 215-d) may be assisted by one or more other UEs 215 (e.g., a UE 215-a, which may be in an idle state or a connected state). In some examples, the assistance may be based on a first UE 215 (e.g., or multiple UEs 215) obtaining on-demand system information 230 and sharing (e.g., transmitting, outputting, broadcasting, sending) the on-demand system information 230 to other UEs 215. In some examples, the assistance may be based on the other UEs 215 requesting the system information from the first UE 215, and the first UE 215 may share the requested information accordingly. Additionally, or alternatively, the assistance may be implemented in accordance with the UEs 215 being configured in a UE group 220, which may be based on relative geographic proximity of the UEs 215 from the other UEs 215.

Additionally, the first UE may send an uplink wake-up signal (UL-WUS) on behalf on other UEs 215, and the UL-WUS may be used to requesting the system information or synchronization or SSB. In such cases, one or more UEs 215 may be selected or configured to send the UL-WUS on behalf of the other UEs 115. The selected UE 115 may monitor for UL-WUS feedback and broadcast the feedback information to other UEs (e.g., other UEs 215 in the group). UEs 215 may subsequently acquire system information from the UEs 215 that successfully received the system information.

In accordance with various aspects described herein, various signaling techniques are proposed to support collaboration between the various UEs 215 for system information acquisition and UL-WUS (e.g., on-demand system information) transmission. For example, signaling between an assisting UE 215 and an assisted UE may be exchanged (e.g., over a local connection) prior to or during the on-demand system information acquisition process. Additionally, different levels of cooperation are proposed to support on-demand system information acquisition, and the signaling may be dependent on a level of cooperation. The signaling may support transmission of information that supports on-demand system information acquisition. Moreover, signaling enhancements are proposed to reduce signaling overhead for sharing on-demand system information. As described herein, UL-WUS may support acquisition of SIB1 (e.g., on-demand SIB1) acquisitions, but similar frameworks may be used for on-demand SIBx (other types of system information) such as by using a first message (Msg1) or a third message (Msg3) in a random access (RACH) procedure.

As described herein, assisting UEs (e.g., the UE 215-a) and the assisted UEs (e.g., UE 215-c) may adopt different levels of cooperation for on-demand system information acquisition. In accordance with a first level of cooperation, the assisting UE 215-a acquires the UL-WUS configuration from an anchor cell (e.g., a cell supported by the network entity 205-a, an anchor cell, cellA) or preamble configuration, and the assisting UE 215- may share the UL-WUS configuration or preamble configuration with one or more assisted UEs (e.g., UE 215-b), which, in-turn, proceed with on-demand system information acquisition using the configuration(s). In accordance with a second level of cooperation, the assisting UE 215-a sends the on-demand system information request (e.g., UL-WUS, Msg 1, Msg3) on behalf of the assisted UE 215-b, and the assisted UE 215-b monitors for feedback from the network entity 205-a and receive on-demand system information 230 (e.g., SIBs). In accordance with a third level of cooperation, the assisting UE 215-a also (e.g., in addition to the second level of cooperation) monitors for feedback from the network entity 205-a (e.g., feedback in response to the system information request), and the assisted UE 215-b receives the SIBs (e.g., the on-demand system information 230) from the network entity 205-a. In accordance with a fourth level of cooperation, the assisted UE also receives the on-demand system information 230 (e.g., in addition to the third level of cooperation) and broadcasts or transmits the on-demand system information 230 (e.g., locally) to the assisted UE 215-b. To support such levels of cooperation, the assisting UE 215-b and one or more assisted UEs 215-b, 215-c and 215-d may establish relationships and/or share coordination information.

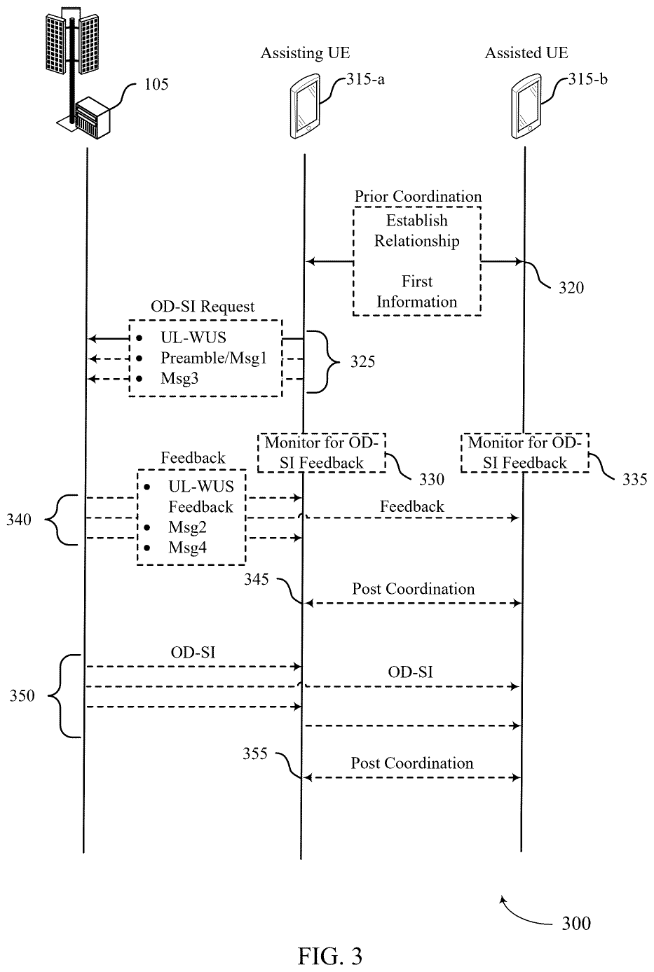

FIG. 3 shows an example of a process flow 300 that supports user equipment cooperation for assisted system information acquisition in accordance with one or more aspects of the present disclosure. The process flow 300 may implement or be implemented to realize aspects of the wireless communications system 100 and the wireless communications system 200. For example, the process flow 300 may illustrate communication between a UE 315-a, a UE 315-b, and a network entity 105, which may be examples of corresponding devices described herein, including with reference to FIGS. 1 and 2 (e.g., UEs 115, UEs 215, network entities 105, network entities 205). Alternative examples of the following may be implemented. For example, some steps may be performed in a different order than described or may not be performed at all. In some implementations, steps may include additional features not mentioned below, or further steps may be added. Further, although the UEs 315 and the network entity 105 are shown performing the operations of the process flow 300, some aspects of some operations may also be performed by one or more other wireless communication devices. Additionally, the communications between the UE 315-a and the UE 315-b (e.g., the local communications) may be sidelink message (e.g., PC5 interface messages), Wi-Fi messages, etc.

At 320, the UE 315-a (e.g., the assisting UE 315-a) and the UE 315-b (e.g., the assisted UE 315-b) may exchange one or more messages for prior coordination, or coordination before system information acquisition. In some examples, the prior coordination may include one or more discovery messages exchanged between the UE 315-a and the UE 315-b (e.g., in the context of sidelink communications), such as part of establishing a relationship or communication link between the UEs 315. For example, to establish the relationship, the UEs 315 may exchange information to establish a PC5-RRC connection (e.g., a communication link 225). As described in further detail herein, the prior coordination, at 320, may include information related to retransmission of an uplink on-demand system information request and/or information related to behavior/signaling when the requests fail (e.g., when either UE 315 fails to receive feedback or on-demand system information).

In some cases, the UE 315-a and the UE 315-b may exchange information (e.g., first information) that is indicative of a maximum allowable quantity of retransmissions of an on-demand system information request to be transmitted by the assisting UE 315-a. That is, the UE 315-a may agree to transmit (or indicate to the UE 315-b) up to N retransmissions of the on-demand system information (OD-SI) request, such that N={0, 1, . . . , Nₘₐₓ}. In some cases, the maximum allowable quantity of retransmissions (N) is fixed or preconfigured, such that it is equal to a maximum allowed quantity of retransmissions of on-demand system information requests by the cell. In some examples, the value of N may be advertised (e.g., broadcast, transmitted) by the UE 315-a, requested by the UE 315-b, and/or negotiated between the two or more UEs 315. For example, the UE 315-b may transmit, to the UE 315-a a request to perform up to the N retransmission of the on-demand system information request. In some cases, selection of N, by the assisting UE 315-a, may be based on an estimated link budget with the target cell (e.g., the network entity 105). As such, different values for N may be indicated or configured for different target cells.

Additionally, or alternatively, a limit on the quantity of times the assisted UE 315-b asks (e.g., requests) the assisting UE 315-a to acquire the on-demand system information (or send requests for the on-demand system information) may be defined. This limit may be referred to an assistance request limit (e.g., Rₘₐₓ) and may be based on a selection by the assisting UE 315-a. Thus, after receiving too many request (e.g., at or above the limit), then the assisting UE 315-a may reject the request by the assisted UE 315-b and optionally provide a cause for the rejection (e.g., due to too many requests). The maximum quantity of requests (e.g., the assistance request limit) may be based on the target cell, the type of system information requested, or more generally, and the limit may be applied within time window or time duration T. In case of on-demand system information, each request by the assisted UE 315-b may trigger up to n (where n={1, 2, . . . , N}) (re)transmissions of the request by the assisting UE 315-a to the cell (e.g., the network entity 105).

After the prior coordination at 320, the assisting UE 315-a may transmit, at 325, one or more on-demand system information requests. The on-demand system information requests may be in the form of an UL-WUS, a preamble/msg1 transmission in a RACH procedure, and/or a Msg3 of a RACH procedure. In some cases, the type of on-demand system information request may be dependent on the type of system information to be acquired. For example, in the case of SIB1, the one-demand system information is an UL-WUS. The preamble/Msg1 signal may be transmitted for Msg1-based on-demand system information. The Msg3 may be transmitted for Msg3-based on-demand system information. In case of using Msg3, the UE 315-a and the network entity 105 may also exchange RACH Msg1 and Msg2 (e.g., prior to using Msg3 to request the on-demand system information).

After transmitting the one or more on-demand system information requests, the assisting UE 315-a, the assisted UE 315-b, or both may monitor for feedback associated with the on-demand system information requests. That is, dependent on the level of coordination described herein, either or both UEs 315 may monitor for feedback. In case of the second level of coordination, at 335, the assisted UE 315-b monitors for the feedback (e.g., and receipt of the system information) associated with the one or more on-demand system information requests transmitted by the assisting UE 315-a. In case of the third level of coordination, at 330, the assisting UE 315-b monitors for the feedback (e.g., in addition to the assisted UE 315-b at 335) and the system information.

At 340, the assisting UE 315-a, the assisted UE 315-b, or both may receive feedback (e.g., ACK or NACK) associated with the one or more on demand system information requests transmitted by the assisting UE 315-a. The feedback may be in the form of a UL-WUS feedback message, a Msg2 of a RACH procedure, or a Msg4 of the RACH procedure, dependent on the type of on-demand system information request that is transmitted. At 350, the assisting UE 315-a, the assisted UE 315-b or both may receive the on-demand system information.

In some cases, however, the UEs 315 do not receive feedback (or receive NACKs) or the on-demand system information. In such cases, at 345 or 350, during one or more post coordination procedures, the assisting UE 315-a may notify the assisted UE 315-b regarding a result of transmitting the on-demand system information request(s) (e.g., the failure to acquire the on-demand system information or receive the feedback associated with the request). In some cases, the assisted UE 315-b may utilize a timer, and after expiration of the timer (and in the absence of receiving the feedback or assistance information from either the assisting UE 315-a or the network entity 105), the assisted UE 315-b may assume that the acquisition of the system information is unsuccessful. The timer may be indicated to the UE 315-b by the UE 315-a or the network entity 105, or may be preconfigured.

After the on-demand system information request attempts are exhausted (e.g., the N transmissions), then the UEs 315 may perform various operations. In a first example, the UEs 315 may perform an uplink-single-frequency network (UL-SFN) method to increase the chances of successful uplink on-demand system information and corresponding acquirement of the on-demand system information. In accordance with the UL-SFN technique, the assisting UE 315-a and the assisted UE 315-b may transmit respective on-demand system information requests using a same uplink resources such as to increase the chances of successful receipt at the network entity 105. In such cases, the same uplink resource may be coordinated using the prior coordination signaling (e.g., first information) at 320 and/or post coordination signaling at 345 or 355.

In accordance with one or more other example operations after exhaustion of the on-demand system information request attempts, the assisted UE 315-b may attempt to acquire the system information itself. This option may be performed when a relatively low quantity (e.g., lower than threshold, 0, or 1) system information requests are transmitted by the assisting UE 315-a (e.g., based on N). In accordance with one or more other example operations after exhaustion of the on-demand system information request attempts, the assisted UE 315-b may coordinate with another assisting UE to perform one or more transmissions of the on-demand system information requests. In such cases, a prior coordination between the new assisting UE, the UE 315-a, and/or the assisted UE 315-b may be performed for the new UE to handle retransmissions after one or more requests by the initial assisting UE 315-a. The scheme may be triggered by an explicit indication between one or more of the UEs 315 and/or based on a timer. That is, after exhaustion of the on-demand system information request by the UE 315-a, the UE 315-a may notify another UE or the UE 315-b to utilize the new UE. Or, the UE 315-b may coordinate with the new UE after expiration of the timer.

In cases when another UE (e.g., the assisted UE 315-b or another UE) handles retransmissions of on-demand system information requests after exhaustion by the original assisting UE 315-b, various power-ramping schemes may be considered. In a first example, the transmission power of the initial retransmission of the on-demand system information request by the new UE may be reset to an initial transmission power value (e.g., an initial value set by or associated with the cell). In accordance with a second example, the transmission power of the initial transmission may follow the power ramping of the prior transmission of the on-demand system information request by the original assisting UE 315-a. In such cases, one or more restrictions or limits may be applied. For example, if the quantity of attempts (e.g., on-demand system information requests) by the original assisting UE 315-b is less than the maximum quantity of attempts allowed by the cell (or the value of N), then the new assisting UE (or the assisted UE) may use a transmission power that is increased for up to M quantity of retransmissions by the new assisting UE, where M+quantity of retransmissions by the original assisting UE 315-a is less than or equal to the maximum quantity of attempts allowed by the cell. Once M+the quantity of attempts by the original UE 315-a reaches the maximum quantity, then the transmission power is not increased. In some examples, these power ramping techniques may be used if the estimated downlink power loss by the original UE 315-a and the one or more other UEs 315 (coordinating the retransmissions) is less than a threshold, and the threshold may be configured or indicated to the UEs. Additionally, or alternatively, the network entity 105 may transmit control signaling to authorize or configure the shared power ramping techniques. In some cases, the UE that exhausts a quantity of on-demand system information may inform other UEs of the quantity or transmissions that the UE performed so that the other UEs may identify an initial transmit power.

Thus, according to the techniques described herein, examples of prior coordination information exchanged, shared, or acquired at 320 may include the assisting UE 315-a agreeing to transmit the on-demand system information requests, the quantity of retransmissions of the on-demand system information requests (e.g., a value for N), information indicative of one or more possible other assisting UEs in cases that the (re)transmission of the on-demand system information requests by the UE 315-a fail, and/or information regarding UE behavior when the attempts by the assisting UE 315-a or another assisting UE 315-b fail. As described herein, two or more of the UEs may perform UL-SFN techniques or break cooperation such that the UE 315-a attempts to acquire the on-demand system information.

Additional information may be exchanged at 320 may include the assisting UE 315-a providing cell access information (e.g., cellAccessRelatedInfo), which may include parameters such as public land mobile network identifier (PLMN ID), a tracking area code (TAC), a radio access network area code (RANAC), etc. and unified access control (UAC) related information. In some cases, the UE 315-b may transmit (e.g., to the UE 315-b) an indication of whether the target cell supports always-on SIB1, on-demand SIB1, or no-SIB1 (e.g., non-cell defining SSB). Such information may be indicative of whether the UE 315-a may be able to support acquisition of the system information on behalf of the assisted UE 315-b. Thus, if the cell supports on-demand SIB1, the UL-WUS configuration may be provided as part of the prior coordination/discovery procedure (e.g., relationship establishment). Additionally, if the UE 315-a indicates that the cell supports on-demand other system information (OSI) or always-on OSI, then the UE 315-a may indicate which OSI is on-demand.

Additionally, according to the techniques described herein, examples of post coordination information exchanged, shared, or acquired at 345 or 355 may include the assisting UE 315-a checking with other UEs (e.g., the UE 315-b) as to whether the other UEs received feedback (e.g., second level of coordination) or the system-information (e.g., third level of coordination). For example, the UE 315-a may transmit, one or more other UEs, a request for information indicative of whether the one or more other UEs acquired the feedback or the on-demand system information. Additionally, or alternatively, the post coordination may include the assisting UE 315-b coordinating retransmission(s) of the on-demand system information request. Additionally, or alternatively, the assisted UE 315-b may transmit one or more on-demand system information requests and use one or more of the power ramping schemes described herein. Additionally, or alternatively, the assisting UE 315-a, the assisted UE 315-b, and one or more other UEs may coordinate an UL-SFN technique to acquire the system information. Additionally, or alternatively, the UEs 315 may break coordination and perform system information acquisition independently.

Additional post coordination information that is exchanged at 345 (e.g., before a monitoring window for on-demand system information feedback expires), the UE that receives the feedback (e.g., the UE 315-a or the UE 315-b) may notify (e.g., transmit an indication to) other UEs that the UE received the feedback (e.g., ACK) for the on-demand system information request. This indication may allow the other UEs to stop monitoring for feedback and/or stop transmitting on-demand system information requests. This technique may be applicable to the second level of coordination described herein.

Additional post coordination information that may be exchanged at 345 may include the UE that received feedback (e.g., the assisting UE 315-a) notifying other UEs (e.g., the assisted UE 315-b) when/where to monitor for receiving the on-demand system information from the network entity 105. This technique may be used in the third level of coordination described herein and the indication of the resource (when/where to receive the on-demand system information) may be transmitted after the UE receives the feedback. Additionally, or alternatively, the UE (e.g., the UE 315-a) may share a NACK, such as to notify the other UEs (e.g., the assisted UE 315-b) that the assisting UE 315-a could not receive feedback or received a NACK as feedback. In such cases, when the NACK is not transmitted by the assisting UE 315-a, the assisted UE 315-b may assume that the feedback was received correctly, which may reduce overhead of post coordination signaling (e.g., since NACKs may be less frequent that ACKs).

As described herein, the UEs 315 may coordinate to provide assistance in acquisition of on-demand system information. These techniques may support coordination between UEs 315 without signaling by the network entity 105. However, it may be desirable for the network entity 105 to provide coordination information to one or more of the UEs 315. For example, the network entity 105 may transmit signaling (e.g., control signaling) that is indicative of retransmission configurations for the assisted or delegated requests for on-demand system information. Such signaling may include retransmission configuration information such as power ramping steps, maximum transmission power, maximum quantity of retransmissions, backoff timers, etc. An additional or alternative set of configuration information may be provided and be used by the assisting UEs when sending an on-demand system information requests on behalf of the one or more other assisted UEs. For example, the network entity 105 may provide an indication of Nₘₐₓ or N, an indication of Rₘₐₓ, an indication of T, an indication of whether continuous power ramping or power ramping reset is to be used (and associated information such as the maximum power or maximum quantity of retransmissions). Such information may be provided in one or more types of system information and/or dedicated RRC signaling. Additionally, to support the UL-SFN procedure, a set of configuration information may be provided (e.g., an indication of the UL-SFN resource) by the network entity 105.

In some cases, as part of the prior coordination at 320, the assisting UE 315-a may advertise (e.g., transmit, provide), to idle or inactive UEs, value tag information (e.g., valueTag). For example, the assisting UE 315-a may provide the valueTag for different SIBs, which may allow the assisted UE 315-b to determine whether already acquired SIBs are up-to-date with the most recent system information that the assisting UE 315-b is able to provide. If the assisted UE 315-b determines that one or more SIBs are out-of-date, then the assisted UE 315-b may query (e.g., transmit a request to) the assisting UE 315-a for the updated content of the out-of-date SIBs. The updated SIBs may be obtained in accordance with techniques described herein.

Additionally, or alternatively, the assisted UE 315-b may include valueTag information associated with stored system information (if available) during the prior coordination (e.g., when requesting the system information from the assisting UE 315-a). In such cases, the assisting UE 315-a may transmit the changed or updated system information to the assisted UE 315-b. Thus, when the assisted UE 315-b sends a request for system information acquisition to the assisting UE 315-a over the local link, the assisted UE 315-b may provide a valueTag of the stored SIBs (if any). Then, the assisting UE 315-a may reply with updated system information. That is, the assisting UE 315-a may transmit the difference between the SIB information the assisted UE 315-b already possesses and the most recent SIB information that the assisting UE 315-a possesses. This technique may reduce unnecessary local signaling overhead by sending the information that changed between the most-recent SIBs and the older SIBs. Accordingly, after receiving the system information from one or more other UEs or by acquiring the system information itself, the UE 315-b may select a cell and establish a connection with the cell.

As such, the present disclosure may enable UEs 315 to skip one or more access procedures, including initial access and cell reselection, which may reduce processing overhead and improve resource utilization. That is, a UE 315 may reduce the standard steps and may perform an alternatively set of operations as described herein. For example, the UE 315-b may conduct its access procedure with partially reduced steps, using assisting information obtained from another nearby UE(s) 315-a. Further, the UE 315-b may obtain network system information indirectly from nearby UE(s) 315 or other devices. Thus, the described techniques may support reduced power consumption, reduced signaling overhead, and improved response times, among other benefits.

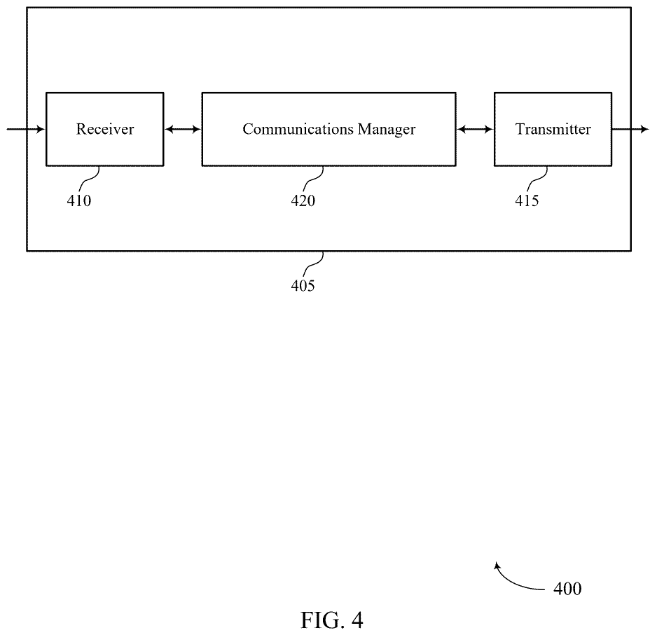

FIG. 4 shows a block diagram 400 of a device 405 that supports user equipment cooperation for assisted system information acquisition in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to user equipment cooperation for assisted system information acquisition). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to user equipment cooperation for assisted system information acquisition). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of user equipment cooperation for assisted system information acquisition as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for establishing a relationship between the first UE and a second UE, where the relationship includes assistance, by the first UE, in acquisition of on-demand system information by the second UE. The communications manager 420 is capable of, configured to, or operable to support a means for acquiring first information associated with acquisition, on behalf of the second UE, of on-demand system information. The communications manager 420 is capable of, configured to, or operable to support a means for transmitting, based on the first information, one or more on-demand system information requests.

Additionally, or alternatively, the communications manager 420 may support wireless communications in accordance with examples as disclosed herein. For example, the communications manager 420 is capable of, configured to, or operable to support a means for establishing a relationship between the first UE and a second UE, where the relationship includes assistance, by the second UE, in acquisition of on-demand system information by the first UE. The communications manager 420 is capable of, configured to, or operable to support a means for acquiring, from the second UE, first information associated with acquisition, by the second UE on behalf of the first UE, of the on-demand system information. The communications manager 420 is capable of, configured to, or operable to support a means for monitoring, based on the first information, for receipt of the on-demand system information.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

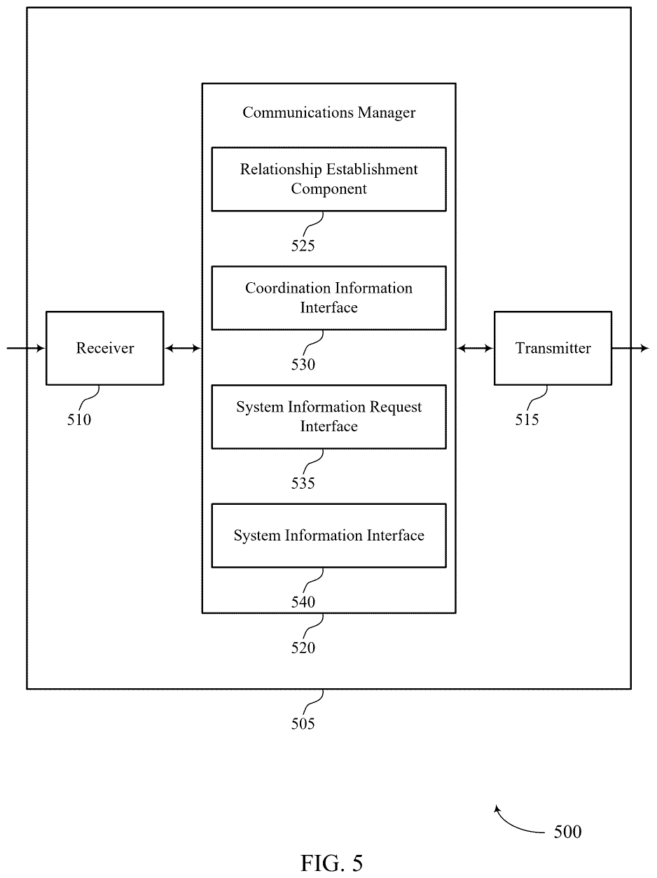

FIG. 5 shows a block diagram 500 of a device 505 that supports user equipment cooperation for assisted system information acquisition in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to user equipment cooperation for assisted system information acquisition). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to user equipment cooperation for assisted system information acquisition). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of user equipment cooperation for assisted system information acquisition as described herein. For example, the communications manager 520 may include a relationship establishment component 525, a coordination information interface 530, a system information request interface 535, a system information interface 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The relationship establishment component 525 is capable of, configured to, or operable to support a means for establishing a relationship between the first UE and a second UE, where the relationship includes assistance, by the first UE, in acquisition of on-demand system information by the second UE. The coordination information interface 530 is capable of, configured to, or operable to support a means for acquiring first information associated with acquisition, on behalf of the second UE, of on-demand system information. The system information request interface 535 is capable of, configured to, or operable to support a means for transmitting, based on the first information, one or more on-demand system information requests.

Additionally, or alternatively, the communications manager 520 may support wireless communications in accordance with examples as disclosed herein. The relationship establishment component 525 is capable of, configured to, or operable to support a means for establishing a relationship between the first UE and a second UE, where the relationship includes assistance, by the second UE, in acquisition of on-demand system information by the first UE. The coordination information interface 530 is capable of, configured to, or operable to support a means for acquiring, from the second UE, first information associated with acquisition, by the second UE on behalf of the first UE, of the on-demand system information. The system information interface 540 is capable of, configured to, or operable to support a means for monitoring, based on the first information, for receipt of the on-demand system information.

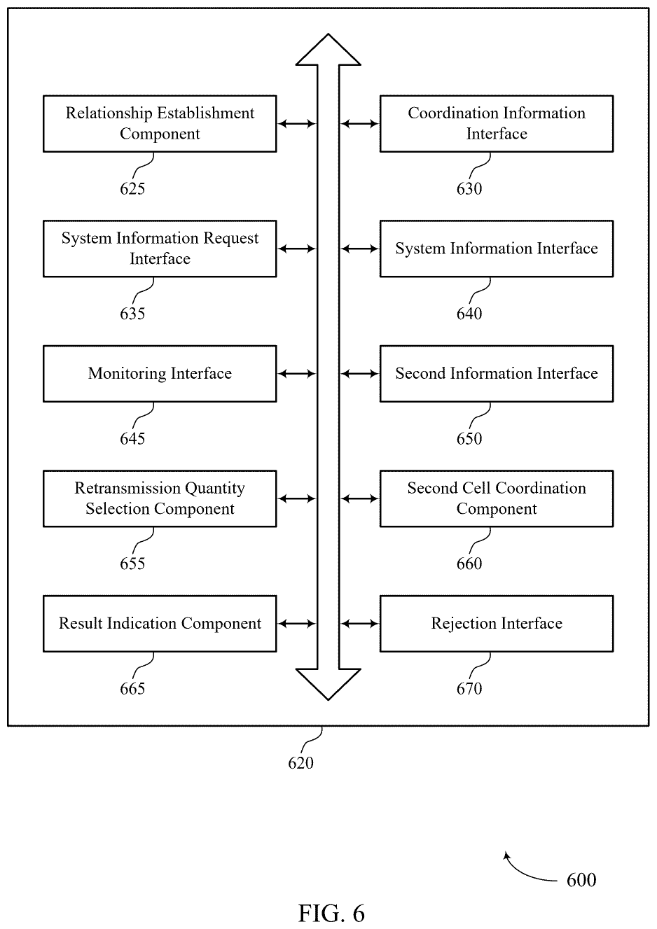

FIG. 6 shows a block diagram 600 of a communications manager 620 that supports user equipment cooperation for assisted system information acquisition in accordance with one or more aspects of the present disclosure. The communications manager 620 may be an example of aspects of a communications manager 420, a communications manager 520, or both, as described herein. The communications manager 620, or various components thereof, may be an example of means for performing various aspects of user equipment cooperation for assisted system information acquisition as described herein. For example, the communications manager 620 may include a relationship establishment component 625, a coordination information interface 630, a system information request interface 635, a system information interface 640, a monitoring interface 645, a second information interface 650, a retransmission quantity selection component 655, a second cell coordination component 660, a result indication component 665, a rejection interface 670, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The relationship establishment component 625 is capable of, configured to, or operable to support a means for establishing a relationship between the first UE and a second UE, where the relationship includes assistance, by the first UE, in acquisition of on-demand system information by the second UE. The coordination information interface 630 is capable of, configured to, or operable to support a means for acquiring first information associated with acquisition, on behalf of the second UE, of on-demand system information. The system information request interface 635 is capable of, configured to, or operable to support a means for transmitting, based on the first information, one or more on-demand system information requests.

In some examples, to support acquiring the first information, the coordination information interface 630 is capable of, configured to, or operable to support a means for acquiring an indication of a maximum allowable quantity of retransmissions of the one or more on-demand system information requests.

In some examples, the maximum allowable quantity of retransmissions is based on a maximum quantity of system information requests defined in a target cell.

In some examples, to support acquiring the indication of the maximum allowable quantity of retransmissions, the coordination information interface 630 is capable of, configured to, or operable to support a means for receiving the indication from the second UE.

In some examples, to support establishing the relationship, the relationship establishment component 625 is capable of, configured to, or operable to support a means for transmitting, to the second UE, an indication of a first maximum allowable quantity of retransmissions of the one or more on-demand system information requests.

In some examples, the retransmission quantity selection component 655 is capable of, configured to, or operable to support a means for selecting the first maximum allowable quantity of retransmissions of the one or more on-demand system information requests based on an estimated link budget of a link between the first UE and a target cell associated with the on-demand system information.

In some examples, the first maximum allowable quantity of retransmissions of the one or more on-demand system information requests pertains to acquisition of the on-demand system information from a first target cell, and the second cell coordination component 660 is capable of, configured to, or operable to support a means for transmitting a second indication of a second maximum quantity of retransmissions of the one or more on-demand system information requests pertaining to acquisition of second on-demand system information from a second target cell.

In some examples, to support establishing the relationship, the relationship establishment component 625 is capable of, configured to, or operable to support a means for receiving, from the second UE and based on an assistance request limit associated with assistance in acquisition of on demand system information, one or more requests for the assistance in acquisition of on-demand system information, where the one or more on-demand system information requests are transmitted based on the received one or more requests.

In some examples, to support acquiring the first information, the relationship establishment component 625 is capable of, configured to, or operable to support a means for acquiring an indication of the assistance request limit that is associated with a time duration during which the assistance request limit is applicable.

In some examples, to support establishing the relationship, the relationship establishment component 625 is capable of, configured to, or operable to support a means for transmitting, to the second UE, an indication of the assistance request limit that is associated with a time duration during which the assistance request limit is applicable.

In some examples, to support transmitting the one or more on-demand system information requests, the system information request interface 635 is capable of, configured to, or operable to support a means for transmitting respective one or more on-demand system information requests for each received request for the assistance.

In some examples, the monitoring interface 645 is capable of, configured to, or operable to support a means for monitoring for receipt of the on-demand system information or feedback in response to transmitting the one or more on-demand system information requests. In some examples, the second information interface 650 is capable of, configured to, or operable to support a means for transmitting, to the second UE, second information indicative of a result of monitoring for the on-demand system information or the feedback.

In some examples, to support transmitting the second information, the result indication component 665 is capable of, configured to, or operable to support a means for transmitting an indication of the result that indicates that the first UE failed to acquire the on-demand system information in response to the one or more on-demand system information requests or failed to receive feedback associated with the one or more on-demand system information requests.

In some examples, to support transmitting the second information, the result indication component 665 is capable of, configured to, or operable to support a means for transmitting, based on the result being that the first UE failed to receive the feedback, a request for third information indicative of whether the second UE received the feedback.

In some examples, the system information request interface 635 is capable of, configured to, or operable to support a means for transmitting, based on the second information, one or more additional on-demand system information requests.

In some examples, to support transmitting the second information, the result indication component 665 is capable of, configured to, or operable to support a means for transmitting, based on the result being that the first UE received the feedback, an indication that the first UE received the feedback.

In some examples, the second information further includes an indication of a resource via which the second UE is to monitor for the on-demand system information.

In some examples, to support establishing the relationship, the relationship establishment component 625 is capable of, configured to, or operable to support a means for transmitting an indication of an uplink resource via which the first UE and the second UE are to transmit respective one or more on-demand system information requests, where the one or more on-demand system information requests are transmitted via the uplink resource.

In some examples, the second information interface 650 is capable of, configured to, or operable to support a means for transmitting, to the second UE, a third UE, or both, second information indicative of a quantity of transmissions of the one or more on-demand system information requests.

In some examples, to support establishing the relationship, the relationship establishment component 625 is capable of, configured to, or operable to support a means for transmitting cell information indicative of a public land mobile network identifier, a tracking area code, a radio access network area code, unified access control information, or a combination thereof.

In some examples, to support establishing the relationship, the relationship establishment component 625 is capable of, configured to, or operable to support a means for transmitting cell information indicative of a configuration of system information transmissions by a target cell, where the configuration indicates that the target cell transmits periodic system information of a first type, the on-demand system information of the first type, no system information of the first type, on-demand system information of a second type, or a combination thereof.

In some examples, to support establishing the relationship, the relationship establishment component 625 is capable of, configured to, or operable to support a means for transmitting an indication of a configuration associated with transmission of an uplink wake-up signal.

In some examples, to support acquiring the first information, the coordination information interface 630 is capable of, configured to, or operable to support a means for receiving, from a network entity, the first information indicative of a maximum quantity of retransmissions of an on-demand system information request, a time duration during which the maximum quantity of retransmissions is applicable, a power ramping configuration associated with the assistance in acquisition of the on-demand system information, or a combination thereof.

In some examples, to support establishing the relationship, the relationship establishment component 625 is capable of, configured to, or operable to support a means for transmitting, to the second UE, value tag information associated with one or more elements of system information acquired by the first UE.

In some examples, to support acquiring the first information, the coordination information interface 630 is capable of, configured to, or operable to support a means for receiving, from the second UE, value tag information associated with one or more elements of system information acquired by the second UE.

Additionally, or alternatively, the communications manager 620 may support wireless communications in accordance with examples as disclosed herein. In some examples, the relationship establishment component 625 is capable of, configured to, or operable to support a means for establishing a relationship between the first UE and a second UE, where the relationship includes assistance, by the second UE, in acquisition of on-demand system information by the first UE. In some examples, the coordination information interface 630 is capable of, configured to, or operable to support a means for acquiring, from the second UE, first information associated with acquisition, by the second UE on behalf of the first UE, of the on-demand system information. The system information interface 640 is capable of, configured to, or operable to support a means for monitoring, based on the first information, for receipt of the on-demand system information.

In some examples, to support acquiring the first information, the coordination information interface 630 is capable of, configured to, or operable to support a means for acquiring an indication of a maximum allowable quantity of retransmissions, by the second UE, of one or more on-demand system information requests.

In some examples, to support establishing the relationship, the relationship establishment component 625 is capable of, configured to, or operable to support a means for transmitting, to the second UE, one or more requests for a quantity of retransmissions, by the second UE, of an on-demand system information request.

In some examples, the rejection interface 670 is capable of, configured to, or operable to support a means for receiving, from the second UE, an indication of rejection of a first request of the one or more requests.

In some examples, to support establishing the relationship, the relationship establishment component 625 is capable of, configured to, or operable to support a means for transmitting, to the second UE, a request for a quantity of retransmissions, by the second UE, of an on-demand system information request.

In some examples, to support establishing the relationship, the relationship establishment component 625 is capable of, configured to, or operable to support a means for transmitting, to the second UE and based on an assistance request limit associated with assistance in acquisition of on demand system information, one or more requests for the assistance in acquisition of on-demand system information.

In some examples, to support acquiring the first information, the coordination information interface 630 is capable of, configured to, or operable to support a means for receiving, from the second UE, an indication of the assistance request limit that is associated with a time duration during which the assistance request limit is applicable.

In some examples, the second information interface 650 is capable of, configured to, or operable to support a means for receiving, from the second UE, second information that indicates that the second UE failed to acquire the on-demand system information in response transmission, by the second UE, of one or more first on-demand system information requests or failed to receive feedback associated with transmission of the one or more first on-demand system information requests.

In some examples, the system information request interface 635 is capable of, configured to, or operable to support a means for transmitting, based on the second information, one or more second on-demand system information requests.

In some examples, to support transmitting the one or more second on-demand system information requests, the system information request interface 635 is capable of, configured to, or operable to support a means for transmitting a second on-demand system information requests using a transmit power that is irrespective of a quantity the one or more first on-demand system information requests.

In some examples, to support transmitting the one or more second on-demand system information requests, the system information request interface 635 is capable of, configured to, or operable to support a means for transmitting a second on-demand system information requests using a transmit power that is based on a quantity the one or more first on-demand system information requests.

In some examples, to support transmitting the one or more second on-demand system information requests, the coordination information interface 630 is capable of, configured to, or operable to support a means for transmitting, using respective transmission powers that increase with each successive transmission, the one or more second on-demand system information requests until satisfaction of a maximum quantity of on-demand system information requests.

In some examples, the coordination information interface 630 is capable of, configured to, or operable to support a means for receiving, from the second UE, an indication of an uplink resource via which the first UE and the second UE are to transmit respective one or more on-demand system information requests. In some examples, the system information request interface 635 is capable of, configured to, or operable to support a means for transmitting, based on the indication and via the uplink resource, one or more on-demand system information requests.

In some examples, the coordination information interface 630 is capable of, configured to, or operable to support a means for receiving, from the second UE, a request for second information that indicates whether the first UE received the on-demand system information in response transmission, by the second UE, of one or more on-demand system information requests, by the second UE, or whether the first UE received feedback associated with the one or more on-demand system information requests.

In some examples, the second information interface 650 is capable of, configured to, or operable to support a means for transmitting, to the second UE, one or more third UEs, or both, second information that indicates that the first UE received feedback associated with transmission, by the second UE, of one or more on-demand system information requests.

In some examples, to support monitoring for the on-demand system information, the system information interface 640 is capable of, configured to, or operable to support a means for monitoring, during a time duration, for receipt of the on-demand system information from the second UE, a network entity, or both. In some examples, to support monitoring for the on-demand system information, the system information interface 640 is capable of, configured to, or operable to support a means for monitoring, during the time duration, for receipt of feedback associated with transmission, by the second UE, of one or more on-demand system information requests.

In some examples, the coordination information interface 630 is capable of, configured to, or operable to support a means for transmitting, to a third UE after expiration of a time duration during which the first UE monitors for the on-demand system information, a request for assistance, by the third UE, in acquisition of the on-demand system information by the first UE.

In some examples, the system information interface 640 is capable of, configured to, or operable to support a means for transmitting, to a third UE after receiving information indicative of failure, by the second UE, to receive the on-demand system information or feedback associated with transmission, by the second UE, of one or more on-demand system information requests.

In some examples, the second information interface 650 is capable of, configured to, or operable to support a means for receiving, from the second UE, second information that includes an indication that the second UE received feedback associated with transmission, by the second UE, of one or more on-demand system information requests.

In some examples, the second information further includes an indication of a resource via which the second UE is to monitor for the on-demand system information.

In some examples, to support acquiring the first information, the coordination information interface 630 is capable of, configured to, or operable to support a means for receiving, from the second UE, cell information indicative of a public land mobile network identifier, a tracking area code, a radio access network area code, unified access control information, or a combination thereof.

In some examples, to support acquiring the first information, the coordination information interface 630 is capable of, configured to, or operable to support a means for receiving, from the second UE, cell information indicative of a configuration of system information transmissions by a target cell, where the configuration indicates that the target cell transmits periodic system information of a first type, the on-demand system information of the first type, no system information of the first type, on-demand system information of a second type, or a combination thereof.

In some examples, to support acquiring the first information, the coordination information interface 630 is capable of, configured to, or operable to support a means for receiving, from the second UE, an indication of a configuration associated with transmission of an uplink wake-up signal.

In some examples, to support acquiring the first information, the coordination information interface 630 is capable of, configured to, or operable to support a means for receiving, from the second UE, value tag information associated with one or more elements of system information acquired by the second UE.

In some examples, to support acquiring the first information, the coordination information interface 630 is capable of, configured to, or operable to support a means for transmitting, to the second UE, first tag information associated with one or more elements of system information acquired by first UE.

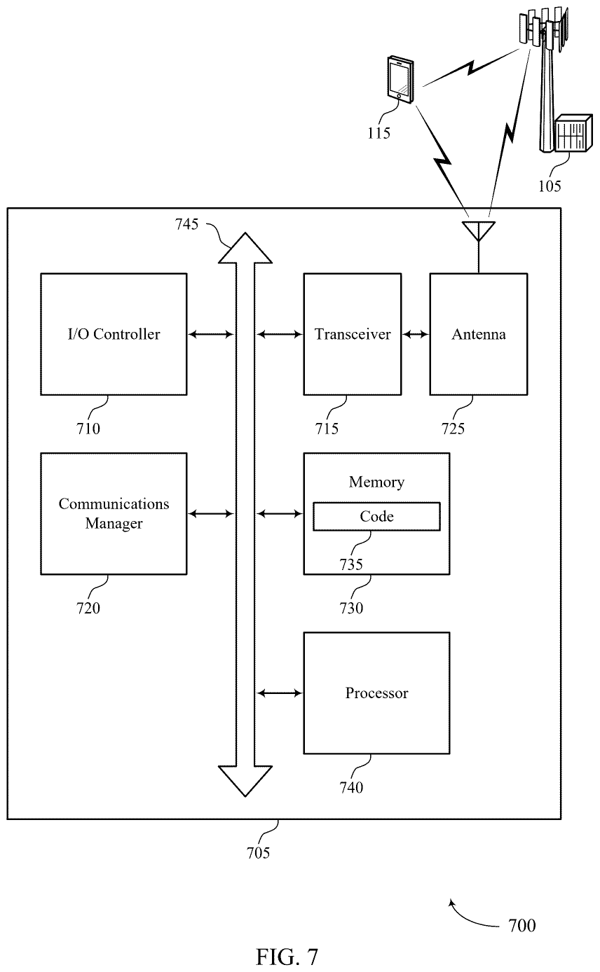

FIG. 7 shows a diagram of a system 700 including a device 705 that supports user equipment cooperation for assisted system information acquisition in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting user equipment cooperation for assisted system information acquisition). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for establishing a relationship between the first UE and a second UE, where the relationship includes assistance, by the first UE, in acquisition of on-demand system information by the second UE. The communications manager 720 is capable of, configured to, or operable to support a means for acquiring first information associated with acquisition, on behalf of the second UE, of on-demand system information. The communications manager 720 is capable of, configured to, or operable to support a means for transmitting, based on the first information, one or more on-demand system information requests.

Additionally, or alternatively, the communications manager 720 may support wireless communications in accordance with examples as disclosed herein. For example, the communications manager 720 is capable of, configured to, or operable to support a means for establishing a relationship between the first UE and a second UE, where the relationship includes assistance, by the second UE, in acquisition of on-demand system information by the first UE. The communications manager 720 is capable of, configured to, or operable to support a means for acquiring, from the second UE, first information associated with acquisition, by the second UE on behalf of the first UE, of the on-demand system information. The communications manager 720 is capable of, configured to, or operable to support a means for monitoring, based on the first information, for receipt of the on-demand system information.

By including or configuring the communications manager 720 in accordance with examples as described herein, the device 705 may support techniques for reduced latency and more efficient utilization of communication resources.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of user equipment cooperation for assisted system information acquisition as described herein, or the at least one processor 740 and the at least one memory 730 may be otherwise configured to, individually or collectively, perform or support such operations.

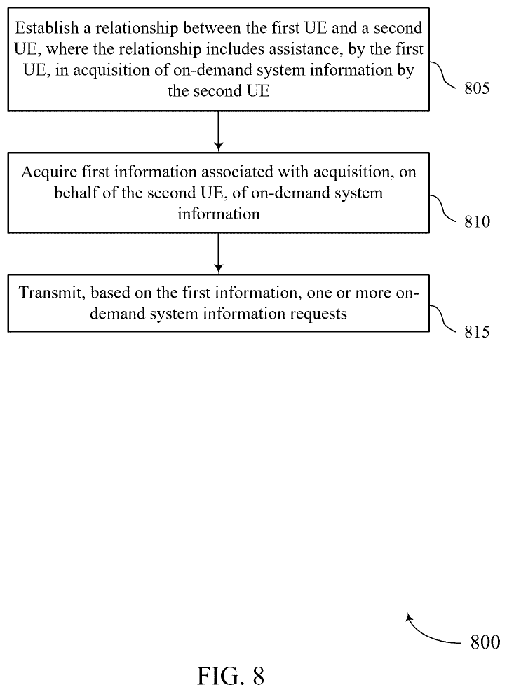

FIG. 8 shows a flowchart illustrating a method 800 that supports user equipment cooperation for assisted system information acquisition in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include establishing a relationship between the first UE and a second UE, where the relationship includes assistance, by the first UE, in acquisition of on-demand system information by the second UE. The operations of 805 may be performed in accordance with examples as disclosed herein. In some examples, aspects of the operations of 805 may be performed by a relationship establishment component 625 as described with reference to FIG. 6.

At 810, the method may include acquiring first information associated with acquisition, on behalf of the second UE, of on-demand system information. The operations of 810 may be performed in accordance with examples as disclosed herein. In some examples, aspects of the operations of 810 may be performed by a coordination information interface 630 as described with reference to FIG. 6.

At 815, the method may include transmitting, based on the first information, one or more on-demand system information requests. The operations of 815 may be performed in accordance with examples as disclosed herein. In some examples, aspects of the operations of 815 may be performed by a system information request interface 635 as described with reference to FIG. 6.

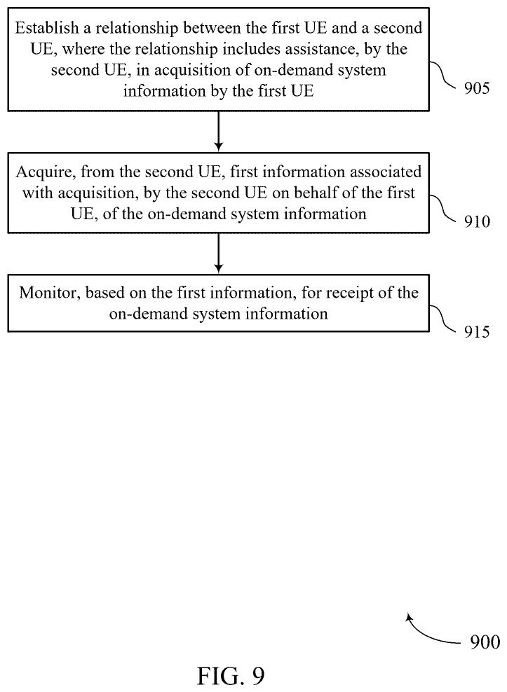

FIG. 9 shows a flowchart illustrating a method 900 that supports user equipment cooperation for assisted system information acquisition in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include establishing a relationship between the first UE and a second UE, where the relationship includes assistance, by the second UE, in acquisition of on-demand system information by the first UE. The operations of 905 may be performed in accordance with examples as disclosed herein. In some examples, aspects of the operations of 905 may be performed by a relationship establishment component 625 as described with reference to FIG. 6.

At 910, the method may include acquiring, from the second UE, first information associated with acquisition, by the second UE on behalf of the first UE, of the on-demand system information. The operations of 910 may be performed in accordance with examples as disclosed herein. In some examples, aspects of the operations of 910 may be performed by a coordination information interface 630 as described with reference to FIG. 6.

At 915, the method may include monitoring, based on the first information, for receipt of the on-demand system information. The operations of 915 may be performed in accordance with examples as disclosed herein. In some examples, aspects of the operations of 915 may be performed by a system information interface 640 as described with reference to FIG. 6.

The following provides an overview of aspects of the present disclosure:
Aspect 1: A method for wireless communications at a first UE, comprising: establishing a relationship between the first UE and a second UE, wherein the relationship includes assistance, by the first UE, in acquisition of on-demand system information by the second UE; acquiring first information associated with acquisition, on behalf of the second UE, of on-demand system information; and transmitting, based at least in part on the first information, one or more on-demand system information requests.
Aspect 2: The method of aspect 1, wherein acquiring the first information comprises: acquiring an indication of a maximum allowable quantity of retransmissions of the one or more on-demand system information requests.
Aspect 3: The method of aspect 2, wherein the maximum allowable quantity of retransmissions is based at least in part on a maximum quantity of system information requests defined in a target cell.
Aspect 4: The method of any of aspects 2 through 3, wherein acquiring the indication of the maximum allowable quantity of retransmissions comprises: receiving the indication from the second UE.
Aspect 5: The method of any of aspects 1 through 4, wherein establishing the relationship comprises: transmitting, to the second UE, an indication of a first maximum allowable quantity of retransmissions of the one or more on-demand system information requests.
Aspect 6: The method of aspect 5, further comprising: selecting the first maximum allowable quantity of retransmissions of the one or more on-demand system information requests based at least in part on an estimated link budget of a link between the first UE and a target cell associated with the on-demand system information.
Aspect 7: The method of any of aspects 5 through 6, wherein the first maximum allowable quantity of retransmissions of the one or more on-demand system information requests pertains to acquisition of the on-demand system information from a first target cell, the method further comprising: transmitting a second indication of a second maximum quantity of retransmissions of the one or more on-demand system information requests pertaining to acquisition of second on-demand system information from a second target cell.
Aspect 8: The method of any of aspects 1 through 7, wherein establishing the relationship comprises: receiving, from the second UE and based at least in part on an assistance request limit associated with assistance in acquisition of on demand system information, one or more requests for the assistance in acquisition of on-demand system information, wherein the one or more on-demand system information requests are transmitted based at least in part on the received one or more requests.
Aspect 9: The method of aspect 8, wherein acquiring the first information comprises: acquiring an indication of the assistance request limit that is associated with a time duration during which the assistance request limit is applicable.
Aspect 10: The method of any of aspects 8 through 9, wherein establishing the relationship comprises: transmitting, to the second UE, an indication of the assistance request limit that is associated with a time duration during which the assistance request limit is applicable.
Aspect 11: The method of any of aspects 8 through 10, wherein transmitting the one or more on-demand system information requests comprises: transmitting respective one or more on-demand system information requests for each received request for the assistance.
Aspect 12: The method of any of aspects 1 through 11, further comprising: monitoring for receipt of the on-demand system information or feedback in response to transmitting the one or more on-demand system information requests; and transmitting, to the second UE, second information indicative of a result of monitoring for the on-demand system information or the feedback.
Aspect 13: The method of aspect 12, wherein transmitting the second information comprises: transmitting an indication of the result that indicates that the first UE failed to acquire the on-demand system information in response to the one or more on-demand system information requests or failed to receive feedback associated with the one or more on-demand system information requests.
Aspect 14: The method of 12, wherein transmitting the second information comprises: transmitting, based at least in part on the result being that the first UE failed to receive the feedback, a request for third information indicative of whether the second UE received the feedback.
Aspect 15: The method of aspect 14, further comprising: transmitting, based at least in part on the second information, one or more additional on-demand system information requests.
Aspect 16: The method of any of aspects 12 through 15, wherein transmitting the second information comprises: transmitting, based at least in part on the result being that the first UE received the feedback, an indication that the first UE received the feedback.
Aspect 17: The method of aspect 16, wherein the second information further includes an indication of a resource via which the second UE is to monitor for the on-demand system information.
Aspect 18: The method of any of aspects 1 through 17, wherein establishing the relationship comprises: transmitting an indication of an uplink resource via which the first UE and the second UE are to transmit respective one or more on-demand system information requests, wherein the one or more on-demand system information requests are transmitted via the uplink resource.
Aspect 19: The method of any of aspects 1 through 18, further comprising: transmitting, to the second UE, a third UE, or both, second information indicative of a quantity of transmissions of the one or more on-demand system information requests.
Aspect 20: The method of any of aspects 1 through 19, wherein establishing the relationship comprises: transmitting cell information indicative of a public land mobile network identifier, a tracking area code, a radio access network area code, unified access control information, or a combination thereof.
Aspect 21: The method of any of aspects 1 through 20, wherein establishing the relationship comprises: transmitting cell information indicative of a configuration of system information transmissions by a target cell, wherein the configuration indicates that the target cell transmits periodic system information of a first type, the on-demand system information of the first type, no system information of the first type, on-demand system information of a second type, or a combination thereof.
Aspect 22: The method of any of aspects 1 through 21, wherein establishing the relationship comprises: transmitting an indication of a configuration associated with transmission of an uplink wake-up signal.
Aspect 23: The method of any of aspects 1 through 22, wherein acquiring the first information comprises: receiving, from a network entity, the first information indicative of a maximum quantity of retransmissions of an on-demand system information request, a time duration during which the maximum quantity of retransmissions is applicable, a power ramping configuration associated with the assistance in acquisition of the on-demand system information, or a combination thereof.
Aspect 24: The method of any of aspects 1 through 23, wherein establishing the relationship comprises: transmitting, to the second UE, value tag information associated with one or more elements of system information acquired by the first UE.
Aspect 25: The method of any of aspects 1 through 24, wherein acquiring the first information comprises: receiving, from the second UE, value tag information associated with one or more elements of system information acquired by the second UE.
Aspect 26: A method for wireless communications at a first UE, comprising: establishing a relationship between the first UE and a second UE, wherein the relationship includes assistance, by the second UE, in acquisition of on-demand system information by the first UE; acquiring, from the second UE, first information associated with acquisition, by the second UE on behalf of the first UE, of the on-demand system information; and monitoring, based at least in part on the first information, for receipt of the on-demand system information.
Aspect 27: The method of aspect 26, wherein acquiring the first information comprises: acquiring an indication of a maximum allowable quantity of retransmissions, by the second UE, of one or more on-demand system information requests.
Aspect 28: The method of any of aspects 26 through 27, wherein establishing the relationship comprises: transmitting, to the second UE, one or more requests for a quantity of retransmissions, by the second UE, of an on-demand system information request.
Aspect 29: The method of aspect 28, further comprising: receiving, from the second UE, an indication of rejection of a first request of the one or more requests.
Aspect 30: The method of any of aspects 26 through 29, wherein establishing the relationship comprises: transmitting, to the second UE, a request for a quantity of retransmissions, by the second UE, of an on-demand system information request.
Aspect 31: The method of any of aspects 26 through 30, wherein establishing the relationship comprises: transmitting, to the second UE and based at least in part on an assistance request limit associated with assistance in acquisition of on demand system information, one or more requests for the assistance in acquisition of on-demand system information.
Aspect 32: The method of aspect 31, wherein acquiring the first information comprises: receiving, from the second UE, an indication of the assistance request limit that is associated with a time duration during which the assistance request limit is applicable.
Aspect 33: The method of any of aspects 26 through 32, further comprising: receiving, from the second UE, second information that indicates that the second UE failed to acquire the on-demand system information in response transmission, by the second UE, of one or more first on-demand system information requests or failed to receive feedback associated with transmission of the one or more first on-demand system information requests.
Aspect 34: The method of aspect 33, further comprising: transmitting, based at least in part on the second information, one or more second on-demand system information requests.
Aspect 35: The method of aspect 34, wherein transmitting the one or more second on-demand system information requests comprises: transmitting a second on-demand system information requests using a transmit power that is irrespective of a quantity the one or more first on-demand system information requests.
Aspect 36: The method of aspect 34, wherein transmitting the one or more second on-demand system information requests comprises: transmitting a second on-demand system information requests using a transmit power that is based at least in part on a quantity the one or more first on-demand system information requests.
Aspect 37: The method of aspect 34 and aspect 36, wherein transmitting the one or more second on-demand system information requests comprises: transmitting, using respective transmission powers that increase with each successive transmission, the one or more second on-demand system information requests until satisfaction of a maximum quantity of on-demand system information requests.
Aspect 38: The method of any of aspects 26 through 37, further comprising: receiving, from the second UE, an indication of an uplink resource via which the first UE and the second UE are to transmit respective one or more on-demand system information requests; and transmitting, based at least in part on the indication and via the uplink resource, one or more on-demand system information requests.
Aspect 39: The method of aspect 26, further comprising: receiving, from the second UE, a request for second information that indicates whether the first UE received the on-demand system information in response transmission, by the second UE, of one or more on-demand system information requests, by the second UE, or whether the first UE received feedback associated with the one or more on-demand system information requests.
Aspect 40: The method of any of aspects 26 and 39, further comprising: transmitting, to the second UE, one or more third UEs, or both, second information that indicates that the first UE received feedback associated with transmission, by the second UE, of one or more on-demand system information requests.
Aspect 41: The method of any of aspects 26 through 40, wherein monitoring for the on-demand system information comprises: monitoring, during a time duration, for receipt of the on-demand system information from the second UE, a network entity, or both, or monitoring, during the time duration, for receipt of feedback associated with transmission, by the second UE, of one or more on-demand system information requests.
Aspect 42: The method of aspect 26, further comprising: transmitting, to a third UE after expiration of a time duration during which the first UE monitors for the on-demand system information, a request for assistance, by the third UE, in acquisition of the on-demand system information by the first UE.
Aspect 43: The method of aspect 26, further comprising: transmitting, to a third UE after receiving information indicative of failure, by the second UE, to receive the on-demand system information or feedback associated with transmission, by the second UE, of one or more on-demand system information requests.
Aspect 44: The method of aspect 26, further comprising: receiving, from the second UE, second information that includes an indication that the second UE received feedback associated with transmission, by the second UE, of one or more on-demand system information requests.
Aspect 45: The method of aspect 44, wherein the second information further includes an indication of a resource via which the second UE is to monitor for the on-demand system information.
Aspect 46: The method of any of aspects 26 through 45, wherein acquiring the first information comprises: receiving, from the second UE, cell information indicative of a public land mobile network identifier, a tracking area code, a radio access network area code, unified access control information, or a combination thereof.
Aspect 47: The method of any of aspects 26 through 46, wherein acquiring the first information comprises: receiving, from the second UE, cell information indicative of a configuration of system information transmissions by a target cell, wherein the configuration indicates that the target cell transmits periodic system information of a first type, the on-demand system information of the first type, no system information of the first type, on-demand system information of a second type, or a combination thereof.
Aspect 48: The method of any of aspects 26 through 47, wherein acquiring the first information comprises: receiving, from the second UE, an indication of a configuration associated with transmission of an uplink wake-up signal.
Aspect 49: The method of any of aspects 26 through 48, wherein acquiring the first information comprises: receiving, from the second UE, value tag information associated with one or more elements of system information acquired by the second UE.
Aspect 50: The method of any of aspects 26 through 49, wherein acquiring the first information comprises: transmitting, to the second UE, first tag information associated with one or more elements of system information acquired by first UE.
Aspect 51: A first UE for wireless communications, comprising one or more memories storing processor-executable code, and one or more processors coupled with the one or more memories and individually or collectively operable to execute the code to cause the first UE to perform a method of any of aspects 1 through 25.
Aspect 52: A first UE for wireless communications, comprising at least one means for performing a method of any of aspects 1 through 25.
Aspect 53: A non-transitory computer-readable medium storing code for wireless communications, the code comprising instructions executable by one or more processors to perform a method of any of aspects 1 through 25.
Aspect 54: A first UE for wireless communications, comprising one or more memories storing processor-executable code, and one or more processors coupled with the one or more memories and individually or collectively operable to execute the code to cause the first UE to perform a method of any of aspects 26 through 50.
Aspect 55: A first UE for wireless communications, comprising at least one means for performing a method of any of aspects 26 through 50.
Aspect 56: A non-transitory computer-readable medium storing code for wireless communications, the code comprising instructions executable by one or more processors to perform a method of any of aspects 26 through 50.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” may include calculating, computing, processing, deriving, investigating, looking up (such as via looking up in a table, a database, or another data structure), ascertaining, and the like. Also, “determining” may include receiving (e.g., receiving information), accessing (e.g., accessing data stored in memory), and the like. Also, “determining” may include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more memories storing processor-executable code; and
one or more processors coupled with the one or more memories and individually or collectively operable to execute the code to cause the first UE to:
establish a relationship between the first UE and a second UE, wherein the relationship includes assistance, by the first UE, in acquisition of on-demand system information by the second UE;
acquire first information associated with acquisition, on behalf of the second UE, of on-demand system information; and
transmit, based at least in part on the first information, one or more on-demand system information requests.

2. The first UE of claim 1, wherein, to acquire the first information, the one or more processors are individually or collectively operable to execute the code to cause the first UE to:
acquire an indication of a maximum allowable quantity of retransmissions of the one or more on-demand system information requests.

3. The first UE of claim 2, wherein the maximum allowable quantity of retransmissions is based at least in part on a maximum quantity of system information requests defined in a target cell.

4. The first UE of claim 2, wherein, to acquire the indication of the maximum allowable quantity of retransmissions, the one or more processors are individually or collectively operable to execute the code to cause the first UE to:
receive the indication from the second UE.

5. The first UE of claim 1, wherein, to establish the relationship, the one or more processors are individually or collectively operable to execute the code to cause the first UE to:
transmit, to the second UE, an indication of a first maximum allowable quantity of retransmissions of the one or more on-demand system information requests.

6. The first UE of claim 5, wherein the one or more processors are individually or collectively further operable to execute the code to cause the first UE to:
select the first maximum allowable quantity of retransmissions of the one or more on-demand system information requests based at least in part on an estimated link budget of a link between the first UE and a target cell associated with the on-demand system information.

7. The first UE of claim 5, wherein the first maximum allowable quantity of retransmissions of the one or more on-demand system information requests pertains to acquisition of the on-demand system information from a first target cell, and the one or more processors are individually or collectively further operable to execute the code to cause the first UE to:
transmit a second indication of a second maximum quantity of retransmissions of the one or more on-demand system information requests pertaining to acquisition of second on-demand system information from a second target cell.

8. The first UE of claim 1, wherein, to establish the relationship, the one or more processors are individually or collectively operable to execute the code to cause the first UE to:
receive, from the second UE and based at least in part on an assistance request limit associated with assistance in acquisition of on demand system information, one or more requests for the assistance in acquisition of on-demand system information, wherein the one or more on-demand system information requests are transmitted based at least in part on the received one or more requests.

9. The first UE of claim 8, wherein, to establish the relationship, the one or more processors are individually or collectively operable to execute the code to cause the first UE to:
transmit, to the second UE, an indication of the assistance request limit that is associated with a time duration during which the assistance request limit is applicable.

10. The first UE of claim 8, wherein, to transmit the one or more on-demand system information requests, the one or more processors are individually or collectively operable to execute the code to cause the first UE to:
transmit respective one or more on-demand system information requests for each received request for the assistance.

11. The first UE of claim 1, wherein the one or more processors are individually or collectively further operable to execute the code to cause the first UE to:
monitor for receipt of the on-demand system information or feedback in response to transmitting the one or more on-demand system information requests; and
transmit, to the second UE, second information indicative of a result of monitoring for the on-demand system information or the feedback.

12. The first UE of claim 11, wherein the one or more processors are individually or collectively further operable to execute the code to cause the first UE to:
transmit, based at least in part on the second information, one or more additional on-demand system information requests.

13. The first UE of claim 1, wherein, to establish the relationship, the one or more processors are individually or collectively operable to execute the code to cause the first UE to:
transmit an indication of an uplink resource via which the first UE and the second UE are to transmit respective one or more on-demand system information requests, wherein the one or more on-demand system information requests are transmitted via the uplink resource.

14. The first UE of claim 1, wherein the one or more processors are individually or collectively further operable to execute the code to cause the first UE to:
transmit, to the second UE, a third UE, or both, second information indicative of a quantity of transmissions of the one or more on-demand system information requests.

15. The first UE of claim 1, wherein, to establish the relationship, the one or more processors are individually or collectively operable to execute the code to cause the first UE to:
transmit an indication of a configuration associated with transmission of an uplink wake-up signal.

16. The first UE of claim 1, wherein, to acquire the first information, the one or more processors are individually or collectively operable to execute the code to cause the first UE to:
receive, from a network entity, the first information indicative of a maximum quantity of retransmissions of an on-demand system information request, a time duration during which the maximum quantity of retransmissions is applicable, a power ramping configuration associated with the assistance in acquisition of the on-demand system information, or a combination thereof.

17. The first UE of claim 1, wherein, to establish the relationship, the one or more processors are individually or collectively operable to execute the code to cause the first UE to:
transmit, to the second UE, value tag information associated with one or more elements of system information acquired by the first UE.

18. The first UE of claim 1, wherein, to acquire the first information, the one or more processors are individually or collectively operable to execute the code to cause the first UE to:
receive, from the second UE, value tag information associated with one or more elements of system information acquired by the second UE.

19. A method for wireless communications at a first user equipment (UE), comprising:
establishing a relationship between the first UE and a second UE, wherein the relationship includes assistance, by the first UE, in acquisition of on-demand system information by the second UE;
acquiring first information associated with acquisition, on behalf of the second UE, of on-demand system information; and
transmitting, based at least in part on the first information, one or more on-demand system information requests.

20. A first user equipment (UE) for wireless communications, comprising:
means for establishing a relationship between the first UE and a second UE, wherein the relationship includes assistance, by the first UE, in acquisition of on-demand system information by the second UE;
means for acquiring first information associated with acquisition, on behalf of the second UE, of on-demand system information; and
means for transmitting, based at least in part on the first information, one or more on-demand system information requests.
